(19) United States
(12) Patent Application Publication
(10) Pub. No.: US 2013/0309603 A1
(43) Pub. Date: Nov. 21, 2013

(54) TONER

(71) Applicants: Toru Takahashi, Abiko-shi (JP); Katsuhisa Yamazaki, Numazu-shi (JP); Shuhei Moribe, Mishima-shi (JP); Daisuke Tsujimoto, Toride-shi (JP); Yosuke Iwasaki, Abiko-shi (JP); Masami Fujimoto, Suntou-gun (JP)

(72) Inventors: Toru Takahashi, Abiko-shi (JP); Katsuhisa Yamazaki, Numazu-shi (JP); Shuhei Moribe, Mishima-shi (JP); Daisuke Tsujimoto, Toride-shi (JP); Yosuke Iwasaki, Abiko-shi (JP); Masami Fujimoto, Suntou-gun (JP)

(73) Assignee: CANON KABUSHIKI KAISHA, Tokyo (JP)

(21) Appl. No.: 13/983,243

(22) PCT Filed: Feb. 1, 2012
(86) PCT No.: PCT/JP2012/052800

§ 371 Date: Aug. 1, 2013

(30) Foreign Application Priority Data
Feb. 3, 2011 (JP) 2011021633

(51) Int. Cl. G03G 9/087

(52) U.S. Cl. CPC G03G 9/08797
USPC 430/109.1

(57) ABSTRACT

A toner having toner particles, each of which contains a binder resin and a colorant, wherein in viscoelastic properties of the toner as measured with a rotating flat plate rheometer at a frequency of 6.28 rad/sec:
a storage elastic modulus at the temperature of 60° C. (G′60) is in a range from 1.0×10⁷ to 1.0×10⁹ (Pa), and
a maximal value (G′p) exists for the storage elastic modulus in a temperature range from 110° C. to 140° C., with this G′p being in a range from 5.0×10⁴ to 5.0×10⁶ (Pa).

### TECHNICAL FIELD

The present invention relates to a toner for use in an image-forming method for developing electrostatic images in electrophotography.

### BACKGROUND ART

As image-forming apparatuses using electrophotographic methods are being used more for quick printing purposes (copying from documents edited on home computers, print-on-demand applications allowing diversified low-volume printing including bookbinding), they are required to handle higher speeds and a variety of transfer materials. However, in the case of large-volume printing on coated papers and other transfer materials that resist toner adhesion in high-speed machines such as those used for quick printing applications, the printed toner may be stripped off by friction between sheets of paper when multiple sheets are loaded after printing, causing reverse marking of the paper. Strategies that have been adopted for dealing with this include reducing the process speed when printing with transfer materials such as coated paper, and fixing the toner more firmly to the transfer material. Thus further improvements in the low-temperature fixability of toner are needed in order to achieve faster speeds while handling a variety of transfer materials.

One technique for improving the low-temperature fixability of toner is to use a crystalline substance such as crystalline polyester. Crystalline substances have a so-called “sharp-melt” property, whereby the viscosity drops rapidly when the melting point is exceeded. Crystalline substances having melting points in the fixation temperature range are being studied so that this property can be applied to low-temperature fixability.

For example, Patent Document 1 proposes an encapsulated toner comprising encapsulated crystalline polyester, wherein the sharp-melt property is specified in terms of viscoelasticity.

Patent Document 2 discloses a pulverized toner using an amorphous polyester having poor compatibility with a crystalline polyester, which remains as crystals in the toner.

Various studies such as these have been made using the sharp-melt property of crystalline substances. The technically difficult issue of blocking resistance associated with compatibility between crystalline substances and other resins has been addressed by encapsulation and by controlling the solubility parameters. However, it is difficult to completely crystallize crystalline substances in toner. Therefore, achieving a balance with blocking resistance can be a problem when the content of a crystalline substance is increased for purposes of low-temperature fixability.

Other research has focused on a property of crystalline substances separate from the sharp-melt property, namely recrystallization in the temperature increase process. For example, Patent Document 3 proposes a toner whereby the abrasion resistance of a fixed image is improved by recrystallization of a crystalline substance. However, the crystalline substance added to this toner has a low recrystallization temperature, and a low melting point. As a result, even if recrystallization occurs in the temperature increase process, the desired effect is not achieved in some cases because the toner melts during the fixing process. Moreover, the substance must be present in an amorphous state in the toner in order to be recrystallized during the temperature increase process. Since a crystalline substance with a low melting point is used, the glass transition temperature is extremely low when the substance is in an amorphous state, so blocking resistance is a problem.

Moreover, although using the sharp-melt property of a crystalline substance to lower the viscosity of the toner is effective if the only goal is low-temperature fixability, this can exacerbate the problem of edge offset.

Continuous feed of a variety of paper sizes from small formats such as postcards and L-size photographs to A3 paper is a common practice in quick printing in particular. In this case, when feeding large A3 paper immediately after continuous output of small-sized paper, the two edges of the paper are fixed by the two edges of the heated roller, which is in an overheated state, and hot offset occurs in these areas (this phenomenon is called “edge offset” below).

Thus, a great many technical issues remain and there is room for further improvement in terms of achieving better low-temperature fixability while maintaining edge offset and blocking resistance.

### CITATION LIST

### Patent Literature

[Patent Document 1] Japanese Patent Application Laid-open No. 2008-268353
[Patent Document 2] Japanese Patent Application Laid-open No. 2007-065620
[Patent Document 3] Japanese Patent Publication No. 4269529

### SUMMARY OF THE INVENTION

### Technical Problems

The present invention provides a toner with good edge offset and blocking resistance, whereby no reverse marking of the paper occurs even when multiple printed pages are loaded.

### Solution to Problem

The toner of the present invention is a toner comprising toner particles, each of which contains a binder resin and a colorant, wherein in viscoelastic properties of the toner as measured with a rotating flat plate rheometer at a frequency of 6.28 rad/sec:

i) a storage elastic modulus at the temperature of 60° C. (G′60) is in a range from 1.0×10⁷ to 1.0×10⁹ (Pa), and

ii) a maximal value (G′p) exists for the storage elastic modulus in a temperature range from 110° C. to 140° C., with this G′p being in a range from 5.0×10⁴ to 5.0×10⁶ (Pa).

### Advantageous Effects of Invention

With the present invention, it is possible to provide a toner with good edge offset and blocking resistance, whereby the mechanical strength of a fixed image is improved and no reverse marking occurs even when multiple printed pages are loaded.

### BRIEF DESCRIPTION OF DRAWINGS

FIG. 1 shows a storage elastic modulus curve for Example 1, to which the present invention is applicable.

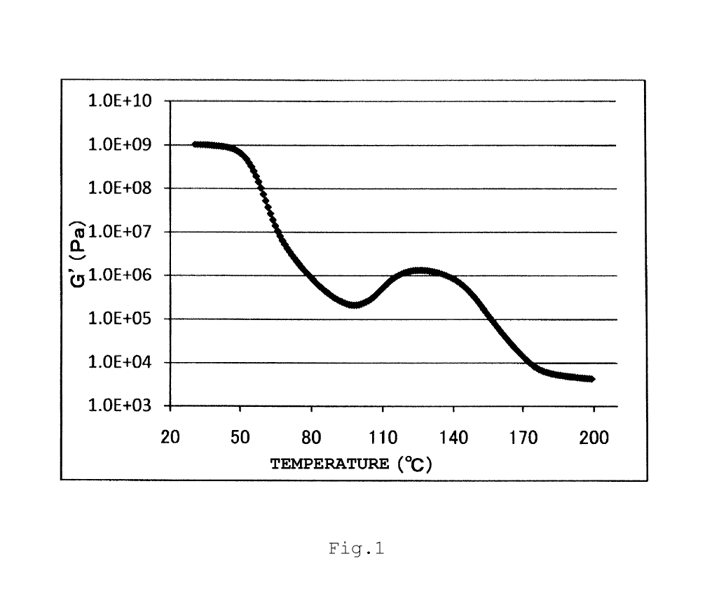

FIG. 2 is a differential curve of the storage elastic modulus curve of FIG. 1.

FIG. 3 shows a storage elastic modulus curve of a conventional toner.

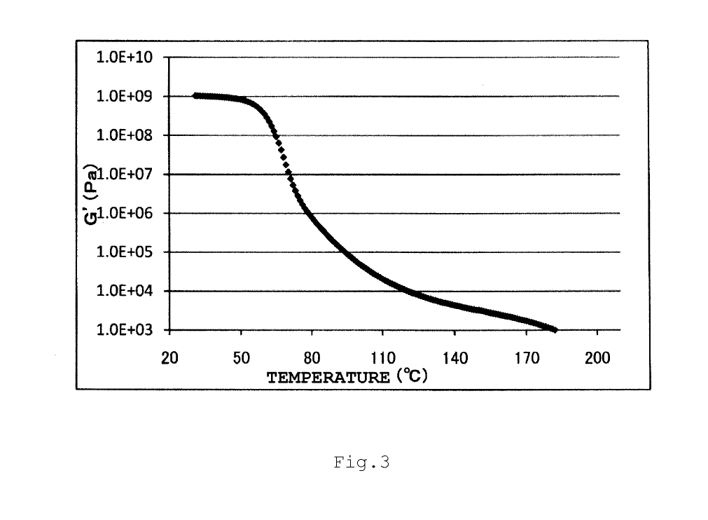

FIG. 4 is a differential curve of the storage elastic modulus curve of FIG. 3.

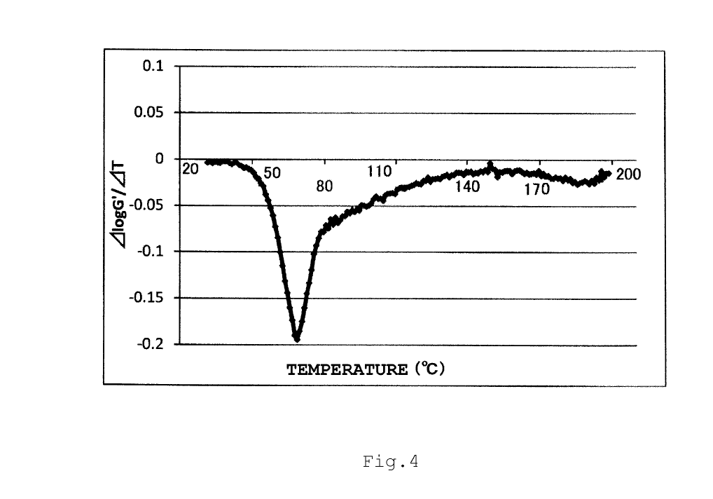

### MODE FOR CARRYING OUT THE INVENTION

As a design concept for a toner to avert reverse marking of the paper when multiple sheets of printed paper are loaded together, the inventors in this case considered that the mechanical strength of the fixed image would be improved if the toner could be fixed adequately to the transfer material. For this purpose, it was thought that a high elastic modulus would be necessary as a property of the toner so that after melting and fixing to the transfer material at the fixation temperature range, the fixed image would not be stripped off by abrasion. After exhaustive research aimed at implementing this concept, it was discovered that excellent fixability with no reverse marking of the paper even using transfer materials such as coated paper could be achieved while maintaining edge offset and blocking resistance by controlling the storage elastic modulus (G′) of the toner.

Specifically, the toner of the present invention is a toner comprising toner particles, each of which contains a binder resin and a colorant, wherein in the viscoelastic properties of the toner as measured with a rotating flat plate rheometer at a frequency of 6.28 rad/sec, a storage elastic modulus at the temperature of 60° C. (G′60) is in a range from 1.0×10⁷ to 1.0×10⁹ (Pa), and a maximal value (G′p) exists for the storage elastic modulus in a temperature range from 110° C. to 140° C., with this G′p being in a range from 5.0×10⁴ to 5.0×10⁶ (Pa).

One feature of the toner of the present invention is the existence of a maximal value for the storage elastic modulus in a temperature range from 110° C. to 140° C. Storage elastic modulus is used as a measure of how much energy is stored in the toner in response to applied strain, and the value of the storage elastic modulus falls when the toner melts and becomes soft. The existence of a maximal value for the storage elastic modulus means that the toner melts and becomes soft in a conventional manner up to that temperature, but within that temperature range the storage elastic modulus increases, which is believed to be direct indication of hardening of the toner. Because this temperature range is believed to be the temperature range which the toner experiences during fixation, it is thought that after melting in the fixing unit, the toner of the present invention hardens again during the fixation process, thereby improving the mechanic strength of the fixed image and providing the effects of the present invention.

The method whereby the storage elastic modulus of the toner is increased at this temperature range is not particularly limited, but one method is recrystallization of the binder resin for example. In addition, it is thought that edge offset is also improved because the storage elastic modulus of the toner is higher during fixation.

When the maximal value occurs at a temperature of less than 110° C., recrystallization may occur before the toner has melted thoroughly, which tends to inhibit fixation and exacerbate reverse marking of the paper. When the temperature exceeds 140° C., on the other hand, recrystallization will be more difficult to achieve during fixation, so that the desired mechanical strength may not obtained and reverse marking may be exacerbated.

In the toner of the present invention, this maximal value [G′p] is in a range from 5.0×10⁴ to 5.0×10⁶ (Pa). By controlling the G′p value within this range, it is possible to obtain a toner providing improved reverse marking and good edge offset. In order to control the G′p within this range, it is necessary to control the part that is softened and the part that is hardened by the temperature. For example, it is important to control the ratio of the amorphous part that a storage elastic modulus decreases as the temperature increases and the part that a storage elastic modulus increases due to recrystallization, as well as the storage elastic moduli of these parts.

In the toner of the present invention, recrystallization is weak when the G′p is less than 5.0×10⁴ (Pa), and edge offset tends to be worse because the viscosity of the toner is low. Above 5.0×10⁶ (Pa), on the other hand, the toner does not attain a sufficiently melted state for fixation because the storage elastic modulus of the amorphous part is too high, and reverse marking of the paper tends to be worse.

The storage elastic modulus at the temperature of 60° C. in the present invention [G′60] is an indicator of the elasticity of the toner near the glass transition temperature. Thus, the G′60 can be used as a benchmark for evaluating blocking resistance. When this value is below 1.0×10⁷ (Pa), blocking resistance is poor. The G′60 tends to decline if a method such as lowering the molecular weight of the binder resin or adding crystalline polyester is used in order to ensure thorough melting of the toner during fixation. To maintain blocking resistance, the G′60 must be in the range from 1.0×10⁷ to 1.0×10⁹ (Pa).

To prepare a toner having the physical properties of the present invention, it is desirable to use a binder resin that is amorphous in the toner but crystallizes during temperature increase. The crystalline polyesters commonly used in toners can only lower the G′60 either because they recrystallize during cooling, or because if they do not recrystallize during cooling, they also fail to recrystallize during temperature increase because they are compatible with the other resin constituent. Thus, the physical properties of the toner of the present invention cannot be achieved with commonly used crystalline polyesters.

Known materials that recrystallize during temperature increase as in the present invention include polyethylene terephthalate (PET) and polybutylene terephthalate (PBT). However, the physical properties of the present invention cannot be obtained by merely adding PET or PBT to an amorphous resin. This is because PET has a high recrystallization temperature, raising the G′p above 140° C. On the other hand, because PBT is less strongly crystalline than PET, it is likely to lose its crystallinity by mixing with other materials in the toner.

To achieve the toner properties of the present invention, it is desirable to control the characteristics of the polymers making up the binder resin in the toner. Desirable properties for a polymer in the binder resin include a hard polymer framework but also strong interactivity for purposes of recrystallization, as in the case of the aforementioned PET. By exploiting such characteristics, it is possible to prepare a toner that solidifies in an amorphous state in the rapid cooling process during toner manufacture, but recrystallizes as it melts and undergoes active micro-Brown movement during fixation. One way of preparing a binder resin that exhibits such characteristic behavior by controlling the types and ratios of monomers for example.

Even in a toner using a binder resin with types and ratios of monomers that undergo recrystallization, however, a maximal value is not detected if the storage elastic modulus is so low that the value is below the measurement threshold at the temperature range at which recrystallization occurs. One method of addressing this problem is to include the gel described below in the toner.

The viscoelastic characteristics of the toner of the present invention are measured by the following methods.

A rotating flat plate rheometer “ARES (TA Instruments)” is used as the measurement equipment.

The measurement sample is a sample of toner that has been pressure molded into a disk shape 2.0±0.3 mm thick and 7.9 mm in diameter with a tablet press at the ambient temperature of 25° C.

The sample is mounted on parallel plates, the temperature is increased from room temperature (25° C.) to 100° C. over the course of 15 minutes, the shape of the sample is adjusted, the temperature is cooled to the start temperature for viscoelasticity measurement, and measurement is initiated. The sample is set so that the initial normal force is 0. Also, as discussed below, the effect of normal force is cancelled out by automatic tension adjustment (Auto Tension Adjustment ON) during subsequent measurement.

Measurement is performed under the following conditions.

(1) Using diameter 7.9 mm parallel plates.

(2) Frequency 6.28 rad/sec (1.0 Hz).

(3) Initial applied strain (Strain) set to 0.1%.

(4) Measurement is performed in a temperature range from 30° C. to 200° C. at a rate of temperature increase (Ramp Rate) of 2.0° C./min. The set conditions are as follows in automatic adjustment mode. Measurement is performed in automatic strain adjustment mode (Auto Strain).

(5) Maximum applied strain (Max Applied Strain) set to 20.0%.

(6) Maximum torque (Max Allowed Torque) set to 200.0 g·cm, and minimum torque (Min Allowed Torque) to 0.2 g·cm.

(7) Strain Adjustment set to 20.0% of Current Strain. Automatic tension adjustment mode (Auto Tension) is adopted for measurement.

(8) Auto Tension Direction set to Compression.

(9) Initial Static Force set to 10.0 g, and Auto Tension Sensitivity set to 40.0 g.

(10) Auto Tension operating condition: Sample Modulus 1.0×10³ (Pa) or more.

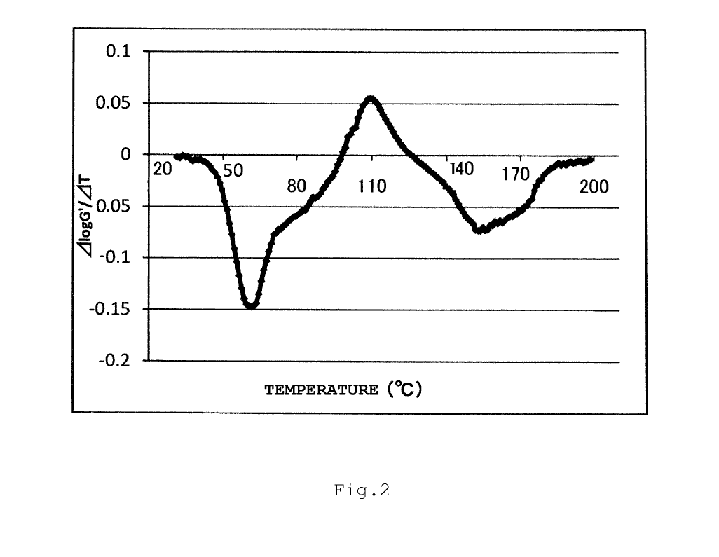

In the present invention, the maximal value is determined as follows. First, the measurement results for storage elastic modulus G′ are plotted against temperature, with the temperature on the horizontal axis and the common logarithm log G′ of the storage elastic modulus G′ on the vertical axis. Once plotted, each point is connected smoothly to obtain a temperature-storage elastic modulus curve. The slope of the resulting temperature-storage elastic modulus curve is determined, and the differential curve of the common logarithm log G′ differentiated by temperature is graphed (see FIG. 2 for example). Specifically, the slope of the temperature-storage elastic modulus curve is determined as the displacement of the temperature-storage elastic modulus curve between a given temperature T(° C.) and T+1 (° C.) (with T being an integer), and the slope between temperature T (° C.) and T+1 (° C.) for example is then used as the differential value at temperature T+0.5 (° C.). This differential value is calculated for all temperature ranges, and the temperatures are plotted on the horizontal axis and the differential values on the vertical axis, and joined smoothly to obtain a differential curve.

To obtain the maximal value in the present invention, the differential curve is given as f′(x), and the x value at which f′(x)=0 is the temperature having the maximal value as f′(x) changes from f′(x)>0 to f′(x)<0. The storage elastic modulus at this temperature is the G′p value.

Depending on the precision of the measurement instrument, there may be cases in which f′(x)>0 at only one point and there is no continuous increase in storage elastic modulus, but this is considered noise, and not a maximal value. In the present invention, the maximal value is the point at which f′(x)=0 when f′(x) yields values of f′(x)>0 continuously at a temperature range of 5° C. and above, and then changes to f′(x)<0.

Measurement values at 3 or 5 points can also be subjected together to smoothing treatment to make it easier to smoothly connect the temperature-storage elastic modulus plot. Smoothing of 3 points together means that smoothing treatment is performed using the average value for a total of 3 points: a given measurement point and 1 point before and after that point.

As discussed above, mechanical strength is enhanced and reverse marking and edge offset of the paper are improved while maintaining blocking resistance because the toner regains elasticity after melting within the fixation temperature range when the G′60 is controlled within the desired range. Some conventional toners may fulfill the requirements of G′60 and storage elastic modulus in a temperature range from 110° C. to 140° C., but the effects of the present invention are not obtained without the maximal value. In the present invention, having a maximal value means that the toner hardens again after melting, which is a necessary conditions for obtaining the effects of the present invention.

In the present invention, it is also desirable that the storage elastic modulus at the temperature of 180° C. (G′180) be in a range from 1.0×10³ to 5.0×10⁴ (Pa). When the G′180 is within this range, edge offset can be further improved while preventing reverse marking of the paper.

When the G′180 is over 5.0×10⁴ (Pa), reverse marking of the paper may occur because the toner is too hard and is not fixed adequately to the transfer material. When the G′180 is under 1.0×10³ (Pa), sufficient edge offset performance may not be obtained, hence, edge offset performance may be exacerbated. Having a G′180 within this range is an indication that the elasticity of the toner is maintained even at a temperature of 180° C. In the toner of the present invention, one method of maintaining elasticity at 180° C. is to include an ultrahigh-molecular-weight material or in other words a gel in the binder resin.

In the present invention, a known method can be used for including the gel in the toner, without any particular limitations, and it is possible to use a binder resin containing a gel, or a gel prepared by a crosslinking reaction during mixing. In the present invention, a gel in the toner is a tetrahydrofuran (THF)-insoluble matter derived from the binder resin, and can be measured by the methods described below.

One binder resin that undergoes recrystallization can be use for the binder resin, or two or more may be combined. In the present invention, it is desirable that binder resin (A) that undergoes recrystallization and binder resin (B) containing a gel be mixed and functionally separated. This is because recrystallization is less likely to occur if the gel is prepared by a crosslinking reaction because this increases the molecular weight of the binder resin.

When two kinds of binder resin are combined, the mass ratio (A:B) of binder resin (A) that undergoes recrystallization and binder resin (B) containing a gel is preferably in the range of 30:70 to 60:40. If the ratio of binder resin (A) is less than 30:70, the effects of recrystallization tend to be less. If the ratio exceeds 60:40, there is a strong effect of recrystallization, but it is difficult to control the G′180, and edge offset performance may be degraded.

The amount of gel in the toner of the present invention, or in other words the content of the tetrahydrofuran (THF)-insoluble matter derived from the binder resin in the toner, is preferably 10 to 40 mass %. If the amount of gel in the toner is within this range, it is easy to maintain a suitable G′180, and it is achievable to suppress edge offset and reverse marking of the paper.

The amount of gel in the present invention is measured as Soxhlet extraction of the THF-insoluble matter as described below. About 2.0 g of binder resin or toner is weighed (Wig), placed in an extraction thimble (such as No. 86R size 28×100 mm, manufactured by Advantec Toyo Kaisha, Ltd.), mounted in a Soxhlet extractor, and extracted for 16 hours using 200 ml of THF as the solvent. Extraction is performed at a reflux rate that gives 1 extraction cycle every about 4 minutes. After completion of extraction, the extraction thimble is removed and vacuum dried for 8 hours at 40° C., and the extraction residue is weighed (W2g).

The incineration ash from the toner is also weighed (W3g) according to the following procedure.

A 30 ml porcelain crucible is weighed exactly in advance, about 2.0 g of sample is placed in the crucible and weighed exactly, and the exact mass (Wag) of the sample is weighed. The crucible is placed in an electric furnace and heated for about 3 hours at about 900° C., cooled in the electric furnace and then cooled for 1 hour or more in a desiccator at room temperature, and the mass of the crucible is weighed exactly.

The incineration ash (Wbg) is determined:

(Wb/Wa)×100=incineration ash content (mass %).

The mass of the incineration ash (W3g=(Wb/Wa)×W1) is determined from this content.

The THF-insoluble matter of the toner is determined according to the following formula:

The THF-insoluble matter of the toner (mass %)=([W2−W3]/[W1−W3])×100

The THF-insoluble matter of binder resin is determined according to the following formula:

THF-insoluble matter (mass %)=(W2/W1)×100

The aforementioned binder resin (B) containing gel is preferably a hybrid resin in which polyester units (polyester structure) and vinyl copolymer units (vinyl copolymer structure) are chemically bound. Polyester units generally have excellent low-temperature fixability, while vinyl copolymer units have excellent edge offset properties, as well as high compatibility with release agents. A gel structure having these properties can be easily designed by controlling the molecular weight distributions and other physical properties of these two different resins.

The mixing ratio of polyester units to vinyl copolymer units is preferably 50:50 to 90:10 by mass from the standpoint of controlling the crosslinked structure at a molecular level. When the amount of polyester units is less than 50 mass % it will be harder to obtain low-temperature fixability, while when the amount of polyester units is more than 90 mass % the storage properties and dispersed state of the release agent are likely to be affected.

The binder resin (B) containing gel preferably contains 20.0 to 50.0 mass % of tetrahydrofuran (THF)-insoluble matter. In binder resin (B), the tetrahydrofuran (THF)-soluble matter preferably has a peak molecular weight (Mp) of 5000 to 15000 and a weight-average molecular weight (Mw) of 5000 to 300000 as measured with GPC, and a ratio of weight-average molecular weight (Mw) to number-average molecular weight (Mn) (Mw/Mn) of 5 to 50. Edge offset may occur when the Mp and Mw are small and the distribution is sharp. On the other hand, the desired low-temperature fixability is difficult to obtain when the Mp and Mw are large and the distribution is broad. The glass transition temperature of binder resin (B) is preferably 53 to 62° C. from the standpoint of fixability and storability.

Meanwhile, the binder resin (A) that undergoes recrystallization preferably has a glass transition temperature of at least 50° C. but no more than 60° C. in the DSC curve as measured by differential scanning calorimetry.

When the glass transition temperature is within this range, it is possible to favorably control reverse marking of the paper while maintaining the blocking resistance of the toner.

The properties of linear polyesters make them suitable as binder resins having the aforementioned characteristics in the present invention. The following are components of linear polyester resins that are especially desirable for use in the present invention.

The following dicarboxylic acids and derivatives thereof are examples of bivalent acid components for composing polyester resins: benzenedicarboxylic acids or anhydrides thereof such as phthalic acid, terephthalic acid, isophthalic acid, and phthalic anhydride, or their lower alkyl esters; alkyldicarboxylic acids such as succinic acid, adipic acid, sebacic acid, and azelaic acid, or their anhydrides or lower alkyl esters; alkenyl succinic acids or alkyl succinic acids such as n-dodecenyl succinic acid, and n-dodecyl succinic acid, or their anhydrides or lower alkyl esters; and unsaturated dicarboxylic acids such as fumaric acid, maleic acid, citraconic acid, and itaconic acid, or their anhydrides or lower alkyl esters.

As discussed above, it is desirable to orient part of the molecular chain of the binder resin so as to obtain crystallinity. Thus, an aromatic dicarboxylic acid is desirable because it assumes a rigid flat structure, and is easily subject to molecular orientation by π-π interaction due to the abundance of nonlocalized electrons in the π electron system.

Particularly desirable are terephthalic acid and isophthalic acid, which easily assume straight-chain structures. The content of this aromatic dicarboxylic acid is preferably at least 50 mol %, more preferably at least 70 mol %, or especially at least 90 mol % per 100 mol % of acid components in the polyester resin.

The following are examples of bivalent alcohol components in the polyester resin: ethylene glycol, polyethylene glycol, 1,2-propanediol, 1,3-propanediol, 1,3-butanediol, 1,4-butanediol, 2,3-butanediol, diethylene glycol, triethylene glycol, 1,5-pentanediol, 1,6-hexanediol, neopentyl glycol, 2-methyl-1,3-propanediol, 2-ethyl-1,3-hexanediol, 1,4-cyclohexanedimethanol (CHDM), hydrogenated bisphenol A, the bisphenol represented by Formula (1) and derivatives thereof, and the diol represented by Formula (2).

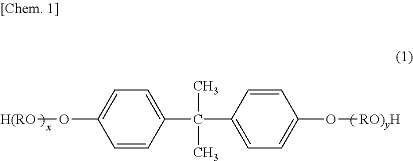

(In the Formula (1), R is an ethylene or propylene group, x and y are each 0 or larger integers, and the average value of x+y is 0 to 10).

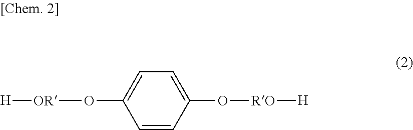

### (In the Formula (2), R′ is

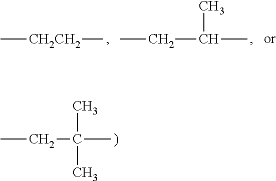

Of these, a straight-chain aliphatic alcohol having 2 to 6 carbon atoms is desirable from the standpoint of orienting part of the molecule and obtaining crystallinity.

However, with this alone the degree of crystallization is too high, and the amorphous properties are lost. It is therefore necessary to break down part of the crystal structure of the polyester resin obtained by combining the aforementioned acid and the aforementioned alcohol. To do this, at least one kind selected from the group consisting of neopentyl glycol, 2-methyl-1,3-propanediol, 1,2-propanediol and the like that assumes a straight-chain structure but has a substituent in a side chain capable of breaking down the crystallinity by steric bulk is used in the amount of preferably 20 mol % to 50 mol % or more preferably 25 mol % to 45 mol % per 100 mol % of alcohol components in the polyester resin.

The polyester resin and polyester units used in the present invention may include as constituents, in addition to the bivalent carboxylic acid compound and bivalent alcohol compound described above, a univalent carboxylic acid compound, univalent alcohol compound, at least trivalent carboxylic acid compound and at least trivalent alcohol compound.

Examples of the univalent carboxylic acid include aromatic carboxylic acids having 30 or less carbon atoms such as benzoic acid, and p-methylbenzoic acid; and aliphatic carboxylic acids having 30 or less carbon atoms such as stearic acid, and behenic acid.

Examples of the univalent alcohol compound include aromatic alcohols having 30 or less carbon atoms such as benzyl alcohol; and aliphatic alcohols having 30 or less carbon atoms such as lauryl alcohol, cetyl alcohol, stearyl alcohol, and behenyl alcohol.

The at least trivalent carboxylic acid compound is not particularly limited, but examples include trimellitic acid, trimellitic anhydride, pyromellitic acid and the like. Examples of the at least trivalent alcohol compound include trimethylol propane, pentaerythritol, glycerin and the like.

The method of manufacturing the polyester resin of the present invention is not particularly limited, and a known method can be used. For example, the aforementioned carboxylic acid compound and alcohol compound can be combined together, and polymerized by means of an esterification or transesterification reaction and a condensation reaction to produce a polyester resin. A polymerization catalyst such as titanium tetrabutoxide, dibutyl tin oxide, tin acetate, zinc acetate, tin disulfide, antimony trioxide, germanium dioxide or the like can be used when polymerizing the polyester resin. The polymerization temperature is not particularly limited but is preferably in the range of 180° C. to 290° C.

In the present invention, a release agent (wax) can be used as necessary to give the toner release properties. From the standpoint of good release properties and ease of dispersal in the toner particles, this wax can preferably be a hydrocarbon wax such as low-molecular-weight polyethylene, low-molecular-weight polypropylene, microcrystalline wax or paraffin wax. One or two or more kinds of wax may also be combined in small quantities as necessary. The following are some examples:

polyethylene oxide wax and other oxides of aliphatic hydrocarbon waxes, or block copolymers of these; carnauba wax, Sasol wax, montanic acid ester wax and other waxes composed primarily of aliphatic esters; and deacidified carnauba wax and other partially or completely deacidified aliphatic esters. Some other examples are: palmitic acid, stearic acid, montanic acid and other saturated straight-chain fatty acids; brassidic acid, eleostearic acid, parinaric acid and other unsaturated fatty acids; stearyl alcohol, aralkyl alcohol, behenyl alcohol, carnaubyl alcohol, seryl alcohol, melissyl alcohol and other saturated alcohols; long-chain alkyl alcohols; sorbitol and other polyvalent alcohols; linoleic acid amide, oleic acid amide, lauric acid amide and other fatty acid amides; methylene-bis stearic acid amide, ethylene-bis caprinoic acid amide, ethylene-bis lauric acid amide, hexamethylene-bis stearic acid amide and other saturated fatty acid bis-amides; ethylene-bis oleic acid amide, hexamethylene-bis oleic acid amide, N,N′-dioleyladipic acid amide, N,N-dioleylsebacic acid amide and other unsaturated fatty acid amides; m-xylene-bis stearic acid amide, N,N-distearylisophthalic acid amide and other aromatic bis-amides; calcium stearate, calcium laurate, zinc stearate, magnesium stearate and other fatty acid metal salts (commonly called metal soaps); waxes obtained by grafting vinyl monomers like styrene and acrylic acid onto aliphatic hydrocarbon waxes; behenic acid monoglyceride and other partial esterification products of fatty acids and polyvalent alcohols; and methyl ester compounds with hydroxyl groups obtained by hydrogenation of vegetable oils.

Specific examples include Viscol™ 330-P, 550-P, 660-P and TS-200 (Sanyo Chemical Industries, Ltd.), Hi-Wax 400P, 200P, 100P, 410P, 420P, 320P, 220P, 210P and 110P (Mitsui Chemicals, Inc.), Sasol H1, H2, C80, C105 and C77 (Sasol Wax), HNP-1, HNP-3, HNP-9, HNP-10, HNP-11 and HNP-12 (Nippon Seiro Co., Ltd.), and Unilin™ 350, 425, 550 and 700 and Unicid™ 350, 425, 550 and 700 (Toyo Petrolite); and Japan wax, beeswax, rice wax, candelilla wax, and carnauba wax (Cerarica NODA). This wax may be added either during molten kneading in the manufacture of the toner or during manufacture of the binder resin, and an existing method can be selected as appropriate.

The wax is preferably added in the amount of at least 1 mass part but no more than 20 mass parts per 100 mass parts of the binder resin. Within this range, it is possible to obtain good release effects while controlling contamination of adjacent members by the wax.

The magnetic iron oxide particles used in the present invention can be magnetic iron oxide particles comprising magnetite, maghemite, ferrite and other magnetic iron oxide particles including other metal oxides. Conventionally known examples include ferrosoferic oxide (Fe₃O₄), iron sesquioxide (γ-Fe₂O₃), zinc iron oxide (ZnFe₂O₄), yttrium iron oxide (Y₃Fe₅O₁₂), cadmium iron oxide (Cd₃Fe₂O₄), gadolinium iron oxide (Gd₃Fe₅O₁₂), copper iron oxide (CuFe₂O₄), lead iron oxide (PbFe₁₂O₁₉), nickel iron oxide (NiFe₂O₄), neodymium iron oxide (NdFe₂O₃), barium iron oxide (BaFe₁₂O₁₉), magnesium iron oxide (MgFe₂O₄), manganese iron oxide (MnFe₂O₄), lanthanum iron oxide (LaFeO₃), iron powder (Fe) and the like. It is particularly desirable that the magnetic iron oxide particles be a fine powder of ferrosoferic oxide or gamma iron sesquioxide. These magnetic iron oxide particles can be used alone, or a combination of two or more can be used. The shape of the magnetic iron oxide particles used in the present invention is preferably an octahedral shape, which has good dispersibility in the toner. In the case of a magnetic toner the magnetic oxide particles can be used as a colorant, but in the case of a non-magnetic toner, one or two or more conventionally known pigments or dyes such as carbon black can be used in known amounts.

A charge control agent can be used in the toner of the present invention to stabilize the charge characteristics. The content of the charge control agent differs depending on the type of charge control agent and the physical properties of the other materials making up the toner particles, but 0.1 mass parts to 10 mass parts or more preferably 0.1 mass parts to 5 mass parts per 100 mass parts of binder resin in the toner particles is generally preferred. A variety of charge control agents can be used depending on the type and purpose of the toner, and one or two or more kinds can be used.

The following can be used to control the negative charge of the toner: organic metal complexes (monoazo metal complexes; acetylacetone metal complexes); and metal complexes or metal salts of aromatic hydroxycarboxylic acids or aromatic dicarboxylic acids. The negative charge of the toner can also be controlled with aromatic mono- and polycarboxylic acids and metal salts and anhydrides thereof; and esters, bisphenols and other bisphenol derivatives. Of these, a monoazo metal complex or metal salt can be used by preference because it provides stable charging characteristics. A charge control resin can also be used, and can be used in combination with the charge control agent described above.

In the toner of the present invention, it is also desirable to use a flowability improver having a strong ability to impart flowability to the surface of the toner particles as an inorganic fine powder, and having a smaller number-average particle size of primary particles with a BET specific surface area of at least 50 m²/g but no more than 300 m²/g. This flowability improver is not particularly limited as long as flowability can be improved after external addition of the flowability improver to the toner particles. The following are some examples: wet silica, dry silica and other fine silica particles, and hydrophobic treated silica obtaining by surface treating such silica with a silane coupling agent, titanium coupling agent or silicone oil or the like.

The inorganic fine powder is preferably used in the amount of at least 0.01 mass parts but no more than 8 mass parts or preferably at least 0.1 mass parts but no more than 4 mass parts per 100 mass parts of toner particles.

Other external additives can also be added as necessary to the toner of the present invention. Examples include charge adjuvants, conductivity-imparting agents, flowability-imparting agents, anti-caking agents, release agents for heat roller fixing, lubricants, and resin fine particles and inorganic fine particles that act as abrasive agents.

Examples of lubricants include ethylene polyfluoride powder, zinc stearate powder and vinylidene polyfluoride powder. Of these, vinylidene polyfluoride powder is preferred. Examples of abrasive agents include cerium oxide powder, silicon carbide powder and strontium titanate powder. These external additives can be thoroughly mixed with a Henschel mixer or other mixer to obtain the toner of the present invention.

To prepare the toner of the present invention, a binder resin, a colorant and other additives are thoroughly mixed in a mixer such as a Henschel mixer or ball mill, then melt kneaded with a heat roller, kneader, extruder or other heat-kneading device, cooled and solidified, and then pulverized and classified to obtain toner particles, and silica fine particles are then thoroughly mixed with these toner particles in a Henschel mixer or other mixer to obtain the toner of the present invention.

Examples of mixers include the Henschel Mixer (Mitsui Mining), Super Mixer (Kawata), Ribocone (Okawara Mfg.), Nauta Mixer, Turbulizer and Cyclomix (Hosokawa Micron Corporation), Spiral Pin Mixer (Pacific Machinery & Engineering Co., Ltd.) and Lodige Mixer (Matsubo). Examples of kneading devices include the KRC kneader (Kurimoto, Ltd.), Buss Co-kneader (Buss Co.), TEM Extruder (Toshiba Machine Co., Ltd.), TEX Twin-screw Kneader (Japan Steel Works, Ltd.), PCM Kneader (Ikegai Iron Works), Three-roll Mill, Mixing Roll Mill and Kneader (Inoue Mfg.), Kneadex (Mitsui Mining), MS Pressure Kneader and Kneader-Ruder (Moriyama Mfg.) and Banbury Mixer (Kobe Steel, Ltd.). Examples of pulverizers include the Counter Jet Mill, Micron Jet and Inomizer (Hosokawa Micron Corporation), IDS mill and PJM Jet Pulverizer (Nippon Pneumatic Mfg. Co., Ltd.), Cross Jet Mill (Kurimoto Ltd.), Ulmax (Nisso Engineering), SK Jet-O-Mill (Seishin Enterprise), Kryptron (Kawasaki Heavy Industries Ltd.), Turbo Mill (Turbo Kogyo) and Super Rotor (Nisshin Engineering). Examples of classifiers include the Classiel, Micron Classifier and Spedic Classifier (Seishin Enterprise), Turbo Classifier (Nisshin Engineering), Micron Separator and Turboplex (ATP), TSP Separator (Hosokawa Micron Corporation), Elbow Jet (Nittetsu Mining), Dispersion Separator (Nippon Pneumatic Mfg. Co., Ltd.) and YM Microcut (Yasukawa Shoji). Examples of sieving devices for sieving the coarse particles include the Ultrasonic (Koei Sangyo Co., Ltd.), Rezona Sieve and Gyrosifter (Tokuju Corp.), Vibrasonic System (Dalton Corp.), Soniclean (Sintokogio Ltd.), Turboscreener (Turbo Kogyo) and Microsifter (Makino Sangyo), and circular vibrating sieves.

The methods of measuring the various physical properties in the present invention are described below.

### <Binder Resin DSC Curve Measurement>

The maximal value, minimal value and quantity of heat of the DSC curve for the binder resin of the present invention are measured with a differential scanning calorimeter “Q1000” (TA Instruments) in accordance with ASTM D3418-82.

Temperature correction of the device detection part is performed using the melting points of indium and zinc, while the heat quantity is corrected using the melting heat of indium.

Specifically, about 5 mg of sample is weighed exactly, placed in an aluminum pan, and measured at a rate of temperature increase of 10° C./min within a measurement temperature range of 30 to 250° C. using an empty aluminum pan as a reference. During measurement, the temperature is first increased to 250° C., then lowered to 30° C. at a rate of temperature decrease of 10° C./min, and then increased again. The physical properties stipulated by the present invention are determined from the endothermic peak of the DSC curve within the temperature range of 30 to 250° C. in the second temperature increase process. A change in specific heat is obtained in this temperature increase process. The point of intersection between the differential thermal curve in this case and a line intermediate between baselines before and after appearance of the change in specific heat is given as the glass transition temperature Tg of the binder resin.

The exothermic peak obtained after the glass transition temperature Tg within the temperature range of 30° C. to 250° C. in this temperature increase process is given as the maximal value, while the endothermic peak obtained from further temperature increase is given as the minimal value. The quantity of heat ΔH of these exothermic and endothermic peaks can be obtained by determining the integral values of the exothermic and endothermic peaks.

### <Binder Resin Softening Point Measurement>

The softening point (Tm) used in the present invention is determined by the following methods.

The softening point of the binder resin is measured using a constant load extrusion capillary rheometer (Flow characteristic evaluating device, Flow Tester CFT-500D, Shimadzu Corporation), according to the device manual. In this device, a constant load is applied to a measurement sample from above with a piston, the measurement sample is melted by increasing the temperature of a cylinder containing the sample, the melted measurement sample is extruded through a die in the bottom of the cylinder, and a rheogram can be obtained showing the relationship between temperature and the amount of descent of the piston. In the present invention, the “½ method melting temperature” described in the device manual accompanying the Flow Tester CFT-500D is given as the melting point. The ½ method melting temperature is calculated by determining ½ of the difference between the amount of descent Smax of the piston at the end of outflow and the amount of descent 5 min of the piston at the beginning of outflow (given as X, with X=(Smax−Smin)/2). The ½ method melting temperature is the temperature of the rheogram when the amount of descent of the piston is the sum of X and Smin.

For the measurement sample, about 1.0 g of binder resin is compression molded for about 60 seconds at about 10 MPa with a tablet press (such as NT-100H, manufactured by NPA Systems) at a temperature of 25° C. to obtain a cylindrical sample about 8 mm in diameter.

Measurement conditions for the CFT-500D are as follows.

Test Mode: Temperature increase method

Starting temperature: 30° C.

Saturated temperature: 200° C.

Measurement interval: 1.0° C.

Ramp rate: 6.0° C./min

Sectional area of piston: 1.000 cm²

Test load (piston load): 30.0 kgf (0.9807 MPa)

Preheating time: 300 seconds

Diameter of die hole: 1.0 mm

Length of die: 1.0 mm

### <Measuring Weight-Average Particle Size (D4) of Toner>

The weight-average particle size (D4) of the toner is measured with a precision particle size analyzer based on a pore electrical resistance method and equipped with an 100 μm aperture tube (Multisizer™ 3 Coulter Counter, Beckman Coulter) together with the dedicated software for setting measurement conditions and analyzing measurement data (Beckman Coulter Multisizer™ 3 Version 3.51, Beckman Coulter), using 25,000 effective measurement channels, and calculated from an analysis of the measurement data.

The aqueous electrolyte solution used for measurement can be a solution of special grade sodium chloride dissolved to a concentration of about 1 mass % in ion-exchanged water, such as “ISOTON II” (Beckman Coulter).

The dedicated software is set as following prior to measurement and analysis.

In the “change standard measurement method (SOM)” screen of the dedicated software, the total count number in control mode is set to 50,000 particles, the number of measurements is set to 1, and a value obtained by using “standard 10.0 μm particles” (manufactured by Beckman Coulter) is set as the Kd value. The threshold and noise level are set automatically by pressing the “threshold/noise level measurement button”. The current is set to 1600 μA and the gain to 2, ISOTON II is set as the electrolyte solution, and a checkmark is placed for aperture tube flush after measurement.

In the “setting for conversion from pulse to particle diameter” screen of the dedicated software, the bin interval is set to logarithmic particle diameter, the number of particle diameter bins is set to 256, and the particle diameter range is set to a range of 2 μm to 60 μm.

The specific measurement methods are as follows.

(1) About 200 ml of the electrolyte solution is placed in a 250 ml round-bottom glass beaker dedicated to the Multisizer 3. The beaker is set in a sample stand, and the electrolyte solution is stirred with a stirrer rod at 24 rotations/sec in a counterclockwise direction. Dirt and bubbles in the aperture tube are then removed by the “aperture flush” function of the dedicated software.

(2) About 30 ml of the electrolyte solution is placed in a 100 ml flat-bottom glass beaker. About 0.3 ml of a solution diluted 3 mass-times prepared by diluting “Contaminon N” (a 10 mass % aqueous solution of a pH 7 neutral detergent for washing precision measuring instruments, including a nonionic surfactant, an anionic surfactant and an organic builder, manufactured by Wako Pure Chemical Industries, Ltd.) with ion-exchanged water is added as a dispersant to the electrolyte solution.

(3) A predetermined amount of ion-exchanged water is placed in the water tank of an “Ultrasonic Dispersion System Tetra 150” ultrasonic disperser (manufactured by Nikkaki Bios Co., Ltd.) with an electrical output of 120 W having two oscillators each with an oscillatory frequency of 50 kHz built in with a phase shift of 180°, and about 2 ml of the Contaminon N is then added to the water tank.

(4) The beaker described in (2) above is set in the beaker fixing hole of the ultrasonic disperser, and the ultrasonic disperser is operated. Then, the height position of the beaker is adjusted so as to maximize the resonance state of the liquid surface of the electrolyte solution in the beaker.

(5) The electrolyte solution in the beaker described in (4) above is exposed to ultrasonic waves as about 10 mg of toner is gradually added to and dispersed in the electrolyte solution. The ultrasonic dispersion treatment is then continued for an additional 60 seconds. The water temperature of the water bath is appropriately adjusted so as to be at least 10° C. but no more than 40° C. during ultrasonic dispersion.

(6) The electrolyte solution described in (5) above with the toner dispersed therein is added dropwise by means of a pipette to the round-bottom beaker described in (1) above in the sample stand, and the measurement concentration is adjusted to about 5%. Then, measurement is performed until 50,000 particles have been measured.

(7) The measurement data is analyzed with the dedicated software of the apparatus, and the weight-average particle diameter (D4) is calculated. The “average diameter” on the “analysis/volume statistics (arithmetic average)” screen of the dedicated software is the weight-average particle diameter (D4) when the dedicated software has been set to graph/volume %.

### EXAMPLES

The present invention is explained in detail below based on examples. However, the present invention is not in any way limited thereby. Unless otherwise specified, the “parts” and “%” compounded below are based on mass.

### Manufacturing Example

### Binder Resin A-1

| | |
|---|---|
| Terephthalic acid | 95 mol parts |
| Fumaric acid | 5 mol parts |
| Ethylene glycol | 70 mol parts |
| Neopentyl glycol | 30 mol parts |

These polyester monomers were loaded into a 5-liter autoclave together with an esterification catalyst. A reflux condenser, moisture separator, N₂ gas introduction tube, thermometer and agitator were attached, and a polycondensation reaction was performed at 230° C. as N₂ gas was introduced into the autoclave. The reaction time was adjusted so as to achieve the desired softening point, and after completion of the reaction the sample was removed from the container, cooled, and pulverized to obtain binder resin A-1. Binder resin A-1 had a Tg of 52.0° C. and a Tm of 97.0° C.

### Manufacturing Example

### Binder Resins A-2 to A-10

The monomers shown in Table 1 were loaded into a 5-liter autoclave together with an esterification catalyst, a reflux condenser, moisture separator, N₂ gas introduction tube, thermometer and agitator were attached, and a polycondensation reaction were performed at 230° C. as N₂ gas was introduced into the autoclave. The reaction time was adjusted so as to achieve the desired softening point, and after completion of the reaction the sample was removed from the container, cooled, and pulverized to obtain binder resins A-2 to A-10. The physical properties of the resins are shown in Table 1.

TABLE 1

| Resin | Acid monomers | | | | Alcohol monomers | | | | | | Resin properties | |
|---|---|---|---|---|---|---|---|---|---|---|---|---|
| No. | | Mol pts | | Mol pts | | Mol pts | | Mol pts | | Mol pts | Tg | Tm |
| A-1 | TPA | 95 | FA | 5 | EG | 70 | NPG | 30 | | | 52.0 | 97.0 |
| A-2 | TPA | 100 | | | EG | 70 | NPG | 30 | | | 52.9 | 95.9 |
| A-3 | TPA | 95 | FA | 5 | EG | 91 | NPG | 39 | | | 55.6 | 102.3 |
| A-4 | TPA | 100 | | | EG | 60 | PG | 40 | | | 55.7 | 98.5 |
| A-5 | TPA | 95 | FA | 5 | EG | 104 | CHDM | 26 | | | 50.0 | 97.2 |
| A-6 | TPA | 95 | FA | 5 | EG | 104 | BPA-EO | 17 | BPA-PO | 9 | 48.9 | 98.5 |
| A-7 | TPA | 100 | | | EG | 100 | | | | | — | 245.0 |
| A-8 | TPA | 100 | | | BD | 100 | | | | | — | 195.0 |
| A-9 | AA | 95 | TMA | 5 | EG | 100 | | | | | — | 155.0 |
| A-10 | TPA | 90 | FA | 10 | EG | 60 | CHDM | 40 | | | 60.0 | 152.0 |

The abbreviations in the table indicate the following compounds.
TPA: Terephthalic acid
FA: Fumaric acid
EG: Ethylene glycol
BPA-EO: Bisphenol A ethylene oxide adduct (average moles added: 2.2 mol)
BMA-PO: Bisphenol A propylene oxide adduct (average moles added: 2.2 mol)
NPG: Neopentyl glycol
CHDM: 1,4-cyclohexane dimethanol
BD: 1,4-butanediol
AA: Adipic acid
TMA: Trimellitic acid
PG: Propylene glycol

### Manufacturing Example

### Binder Resin B-1

| | |
|---|---|
| Bisphenol A ethylene oxide adduct | 48.5 mol parts |
| (average moles added: 2.2 mol) | |
| Terephthalic acid | 34.5 mol parts |
| Adipic acid | 8.0 mol parts |
| Trimellitic anhydride | 5.0 mol parts |
| Acrylic acid | 4.0 mol parts |

These polyester monomers were added to a 4-neck flask, a decompression unit, moisture separation unit, nitrogen gas introduction unit, temperature measurement unit and agitation unit were attached, and the monomers were agitated at 160° C. in a nitrogen gas atmosphere. Vinyl copolymer monomers (85.0 mol parts styrene and 15.0 mol parts 2-ethylhexyl acrylate) mixed with 2.0 mol parts of benzoyl peroxide as a polymerization initiator were then added dropwise over the course of 4 hours with a drip funnel so that the ratio of polyester monomers to vinyl copolymer monomers was 8:2 by mass. This was then reacted for 5 hours at 160° C., the temperature was increased to 230° C. and 0.2 mass % of dibutyl tin oxide was added, and the reaction time was adjusted so that the THF-insoluble matter was 40 mass % to obtain binder resin B-1. Binder resin B-1 had a Tg of 57.0° C. and a Tm of 135.0° C.

### Manufacturing Example

### Binder Resin B-2

Binder resin B-2 was obtained in the same way as binder resin B-1 except that the reaction time was adjusted so that the THF-insoluble matter was 60 mass %. Binder resin B-2 had a Tg of 63.0° C. and a Tm of 145.0° C.

### Manufacturing Example

### Binder Resin B-3

90 mass parts of binder resin A-1 and 10 mass parts of binder resin A-10 were mixed in a 2-liter 4-neck flask with an attached nitrogen introduction tube, dehydration tube, agitator and thermocouple, and dissolved in 700 mass parts of toluene, 1.0 mass part of benzoyl peroxide was added, the mixture was heated to reflux, and the reaction time was adjusted so that the THF-insoluble matter was 20 mass % to obtain binder resin B-3. Binder resin B-3 had a Tg of 54.5° C. and a Tm of 130.2° C.

### Manufacturing Example

### Binder Resin B-4

Binder resin B-4 was obtained in the same way as binder resin B-3 except that the reaction time was adjusted so that the THF-insoluble matter was 40 mass %. Binder resin B-4 had a Tg of 55.3° C. and a Tm of 153.0° C.

### Manufacturing Example

### Toner 1

| | |
|---|---|
| Binder resin A-1 | 40 mass parts |
| Binder resin B-1 | 60 mass parts |
| Magnetic iron oxide particles | 90 mass parts |
| (average particle diameter 0.20 μm, Hc = | |
| 11.5 kA/m, σs = 88 Am²/kg, σr = 14 Am²/kg) | |
| Polyethylene wax | 4 mass parts |
| (PW2000: Baker Petrolite, melting point 120° C.) | |
| Charge control agent | 2 mass parts |
| (T-77, Hodogaya Chemical Co., Ltd.) | |

These materials were premixed in a Henschel mixer, and then melt kneaded with a twin-screw kneading extruder. The resulting kneaded product was cooled, coarsely pulverized with a hammer mill and then pulverized with a jet mill, and the resulting fine powder was classified with a multi-grade classifier utilizing the Coanda effect to obtain negatively triboelectrically charged toner particles with a weight-average particle size (D4) of 6.8 μm. 0.8 mass parts of silica fine particles (original BET specific surface area 300 m²/g, treated with hexamethyldisilazane) and 3.0 mass parts of strontium titanate (number-average particle diameter 1.2 μm) per 100 mass parts of toner particles were added externally and mixed, and the mixture was sieved with a 150 μm mesh to obtain negatively triboelectrically charged Toner 1. The physical properties of Toner 1 are shown in Table 3.

### Manufacturing Example

### Toners 2 to 19

Toners 2 to 19 were obtained in the same way as Toner 1 except that the combinations of binder resins were changed as shown in Table 2. The physical properties are shown in Table 3.

TABLE 2

| | Binder | Mass | Binder | Mass |
|---|---|---|---|---|
| | resin | parts | resin | parts |
| Toner 1 | A-1 | 40 | B-1 | 60 |
| Toner 2 | A-1 | 30 | B-1 | 70 |
| Toner 3 | A-1 | 60 | B-1 | 40 |
| Toner 4 | A-1 | 70 | B-1 | 30 |
| Toner 5 | A-2 | 20 | B-1 | 80 |
| Toner 6 | A-6 | 50 | B-1 | 50 |
| Toner 7 | A-6 | 70 | B-1 | 30 |
| Toner 8 | A-5 | 70 | B-1 | 30 |
| Toner 9 | A-3 | 20 | B-1 | 80 |
| Toner 10 | A-4 | 70 | B-1 | 30 |
| Toner 11 | A-1 | 60 | B-4 | 40 |
| Toner 12 | A-1 | 30 | B-4 | 70 |
| Toner 13 | — | — | B-3 | 100 |
| Toner 14 | A-1 | 70 | B-4 | 30 |
| Toner 15 | A-5 | 70 | B-4 | 30 |
| Toner 16 | A-7 | 50 | B-4 | 50 |
| Toner 17 | A-8 | 10 | B-4 | 90 |
| Toner 18 | A-9 | 20 | B-2 | 80 |
| Toner 19 | A-1 | 100 | — | — |

TABLE 3

| | | Temp at | | | Amount |
|---|---|---|---|---|---|
| | G′60 | maximal | G′p | G′180 | of Gel |
| | (Pa) | value (° C.) | (Pa) | (Pa) | (mass %) |
| Toner 1 | 1.0 × 10⁸ | 116 | 1.1 × 10⁵ | 2.5 × 10⁴ | 24 |
| Toner 2 | 3.0 × 10⁸ | 116 | 7.0 × 10⁴ | 3.5 × 10⁴ | 28 |
| Toner 3 | 7.0 × 10⁷ | 116 | 5.0 × 10⁵ | 8.0 × 10³ | 16 |
| Toner 4 | 5.0 × 10⁷ | 116 | 6.0 × 10⁵ | 2.0 × 10³ | 12 |
| Toner 5 | 1.0 × 10⁹ | 116 | 6.0 × 10⁴ | 4.0 × 10⁴ | 32 |
| Toner 6 | 6.0 × 10⁷ | 112 | 9.0 × 10⁵ | 3.0 × 10³ | 12 |
| Toner 7 | 4.0 × 10⁸ | 116 | 5.0 × 10⁶ | 3.0 × 10³ | 12 |
| Toner 8 | 1.2 × 10⁷ | 116 | 7.0 × 10⁵ | 3.0 × 10³ | 12 |
| Toner 9 | 9.0 × 10⁸ | 116 | 5.2 × 10⁴ | 4.0 × 10⁴ | 32 |
| Toner 10 | 8.0 × 10⁷ | 139 | 2.0 × 10⁵ | 3.0 × 10³ | 12 |
| Toner 11 | 9.0 × 10⁷ | 116 | 8.0 × 10⁵ | 1.0 × 10³ | 16 |
| Toner 12 | 5.0 × 10⁸ | 116 | 9.0 × 10⁴ | 5.0 × 10⁴ | 28 |
| Toner 13 | 8.0 × 10⁸ | 126 | 7.0 × 10⁴ | 6.0 × 10⁴ | 32 |
| Toner 14 | 6.0 × 10⁷ | 116 | 9.0 × 10⁵ | 7.0 × 10² | 12 |
| Toner 15 | 9.0 × 10⁶ | 116 | 5.0 × 10⁵ | 7.0 × 10² | 12 |
| Toner 16 | 1.0 × 10⁹ | 145 | 8.0 × 10⁶ | 2.0 × 10⁴ | 20 |
| Toner 17 | 1.0 × 10⁹ | — | — | 9.0 × 10⁴ | 36 |
| Toner 18 | 1.2 × 10⁷ | — | — | 9.0 × 10⁴ | 48 |
| Toner 19 | 6.0 × 10⁶ | — | — | — | 0 |

### Example 1

The machine used for evaluation in this example was a commercial digital copying machine “imagePress 1135” (Canon Inc.). Toner 1 was substituted for the toner in this evaluation machine, and evaluated as follows.

### <Evaluation of Reverse Marking of Paper>

Using basis weight 104 g/m² matte coated paper as the evaluation paper, a solid black unfixed image was fed into the machine and subjected to 50 g/cm² of load, and the fixed image was rubbed against the reverse side of the same matte coated paper. The density of the reverse side of the coated paper after rubbing was measure with a reflection densitometer (Reflectometer Model TC-6DS, Tokyo Denshoku). The worst value for reflection density of the white part after image formation was given as Ds and the average reflection density of the transfer material before image formation as Dr, and Dr−Ds was given as the amount of toner adhering to the reverse side, and evaluated according to the following standard. The evaluation results are given in Table 4.

A: Extremely good (less than 0.5%)

B: Good (at least 0.5% but less than 2.0%)

C: Normal (at least 2.0% but less than 3.0%)

D: Somewhat poor (at least 3.0% but less than 4.0%)

E: Poor (4.0% or more)

### <Edge Offset>

500 copies of a horizontal line pattern with a print ratio of 2% were printed on A5 size paper, and 100 copies of a horizontal line pattern with an print ratio of 2% were then printed continuously on A4 size paper. The number of pages on which edge offset occurred on the edge of the A4 size paper was checked visually, and evaluated according to the following standard.

A: Extremely good (no offset)

B: Good (disappears by page 5)

C: Normal (disappears by page 15)

D: Somewhat poor (disappears by page 20)

E: Poor (still present after page 20)

### <Blocking Resistance>

10 g of toner was measured into a 50 ml polymer cup and left standing for 3 days in a thermostatic tank at 50° C., and blocking was evaluated visually. The evaluation results are shown in Table 4.

A: Extremely good (no aggregates observed)

B: Good (aggregates disintegrate immediately when cup is shaken)

C: Normal (aggregates grow smaller and disintegrate as cup is shaken)

D: Somewhat poor (aggregates remain even after cup is shaken)

E: Poor (large aggregates remain even after cup is shaken)

### Examples 2 to 14

Examples 2 to 14 were evaluated in the same way as Example 1 except that the toners shown in Table 4 were substituted. The evaluation results are shown in Table 4.

### Comparative Examples 1 to 5

Comparative Examples 1 to 5 were evaluated in the same way as Example 1 except that the toners shown in Table 4 were substituted. The evaluation results are shown in Table 4.

TABLE 4

| | | Reverse marking | Edge | Blocking |
|---|---|---|---|---|
| Example No. | Toner No. | of paper | offset | resistance |
| Example 1 | Toner 1 | A | A | A |
| Example 2 | Toner 2 | A | A | A |
| Example 3 | Toner 3 | A | B | B |
| Example 4 | Toner 4 | A | C | B |
| Example 5 | Toner 5 | B | A | A |
| Example 6 | Toner 6 | A | C | B |
| Example 7 | Toner 7 | A | C | A |
| Example 8 | Toner 8 | A | C | C |
| Example 9 | Toner 9 | B | C | A |
| Example 10 | Toner 10 | B | C | B |
| Example 11 | Toner 11 | B | C | B |
| Example 12 | Toner 12 | C | A | A |
| Example 13 | Toner 13 | C | A | A |
| Example 14 | Toner 14 | B | C | B |
| Comparative | Toner 15 | A | C | E |
| Example 1 | | | | |
| Comparative | Toner 16 | E | A | A |
| Example 2 | | | | |
| Comparative | Toner 17 | E | A | A |
| Example 3 | | | | |
| Comparative | Toner 18 | E | A | E |
| Example 4 | | | | |
| Comparative | Toner 19 | A | E | E |
| Example 5 | | | | |

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2011-021633, filed Feb. 3, 2011, which is hereby incorporated by reference herein in its entirety.

1. A toner comprising toner particles, each of which contains a binder resin and a colorant, wherein:
in viscoelastic properties of the toner as measured with a rotating flat plate rheometer at a frequency of 6.28 rad/sec:
i) a storage elastic modulus at the temperature of 60° C. (G′60) is in a range from 1.0×10⁷ to 1.0×10⁹ (Pa), and
ii) a maximal value (G′p) exists for the storage elastic modulus in a temperature range from 110° C. to 140° C., with this G′p being in a range from 5.0×10⁴ to 5.0×10⁶ (Pa).

2. The toner according to claim 1, wherein:
in the viscoelastic properties of the toner as measured with a rotating flat plate rheometer at a frequency of 6.28 rad/sec,
the storage elastic modulus at the temperature of 180° C. (G′180) is in a range from 1.0×10³ to 5.0×10⁴ (Pa).
